(19) United States
(12) Patent Application Publication
(10) Pub. No.: US 2017/0042132 A1
(43) Pub. Date: Feb. 16, 2017

(54) TRAWLING SKIMMER

(71) Applicant: GEORGE HALLNER, Westwego, LA (US)

(72) Inventor: GEORGE HALLNER, Westwego, LA (US)

(21) Appl. No.: 14/826,493

(22) Filed: Aug. 14, 2015

(51) Int. Cl. A01K 75/00; A01K 61/00; A01K 79/00; A01K 73/06; A01K 73/04

(52) U.S. Cl. CPC A01K 75/00; A01K 73/06; A01K 73/04; A01K 79/00; A01K 61/005

(57) ABSTRACT

A method and system for efficient and eco-friendly shrimp skimmer trawling by a trawling vessel with a trawl net, skimmer booms, net arms, and buoyantly adjustable rollers to maintain trawl net height and net opening without damage to the ocean floor allowing for systematic and frequent retrieval of catch while continuing trawling operations in intervals short enough to prevent death of by-catch and endangered species and where the system is fully storable on trailerable trawling vessels for maintenance of allowable highway heights. The system and method has the upper edge of the trawl net held above the ocean surface while the trawling vessel moves forward.

### BACKGROUND

This invention relates to improved methods and equipment for trawling, and more particularly to an improved method of shrimp trawling to minimize and eliminate the destructive effects of bottom trawling commonly used to trawl for shrimp in coastal regions, particularly in the Gulf of Mexico.

Present shrimp trawling methods typically involve two nets with forward booms pushing the net bottoms below the boat with a heavy bullet for each net used to hold the trawl nets on the sea bottom and keep the mouth of the trawls open as they are pushed or pulled by the trawling vessel. These bullets weigh as much as 800 pounds each. At the outboard end of each net boom is a sled weighing approximately 100 pounds. The net booms are fastened to the deck of the trawling vessel approximately one third of the vessel length aft from the bow. Because of this configuration, the nets are actually under the trawling vessel and propellers resulting in longer times for turning to avoid drawing the nets into the propellers. Along with the destruction to the sea bottom caused by these devices, the bottom edge of the trawl nets being dragged along the sea bottom continually breaks up any vegetation or aquatic life forms on the bottom and causes the release of sediment. This destructive effect is particularly severe in relatively shallow coastal areas trawled for shrimp and has led to the accelerated loss of coastal wetlands.

All around coastal lakes and bays were vast regions of low land inaccessible to trawler boats. When these low lands were made accessible by storms and hurricanes, trawler vessels began using the system described above with increasingly heavier bullets and sleds, churning up sediment causing untold tons of sediment to wash into the ocean with each falling tide. This practice has continued for at least half a century greatly contributing to the loss of coastal lands. In particular, the bottoms of coastal Louisiana bays and lakes are now 8 to 10 feet deeper.

Another detrimental effect of the use of these heavy devices is the need for increasingly large and more powerful trawling vessels to move larger trawl nets with heavier bullets and sleds. Incidental to this increase in size is the added time necessary to pull the trawl nets to unload catch as well as the death of unwanted species commonly called by-catch due to the extended time between pulling of the trawl nets.

### SUMMARY OF THE INVENTION

It is an object of the present invention to eliminate the negative aspects of the present method and equipment used in trawling, particularly shrimp trawling in relatively shallow coastal waters such as along the Gulf of Mexico.

It is an object of the present invention to provide a more efficient and environmentally friendly system and method for trawling with the adaptability to trawl at various levels or water depth ranges suitable to the species being trawled. For example it is well known that “brown” shrimp are trawled during a May spring season near the bottom, whereas “white shrimp” season is later in the year but this species is trawled at all depths or columns of water.

It is a further object of this invention to eliminate heavy boards, bullets or sleds, thereby reducing the power and size of trawling vessels, and also reducing the amount of labor needed to pull the trawl net on a continuous short cycle, thereby eliminating the need for turtle excluders because the turtles would be removed from the water quickly. Likewise, by-catch or unwanted species would be returned to the sea while still alive.

It is a further object of this invention to provide a true skimming trawl that would allow the catch to be retrieved and dumped on the deck or fantail of the trawling vessel in intervals of as little as five minutes while continuing to trawl. This frequent retrieval of the trawl would allow faster sorting of the catch and return of by-catch to the sea. This is in contrast to the present practice of trawling literally for hours and then retrieving heavily laden trawl nets and spending an equally long time sorting through hundreds and hundreds of pounds of catch and dealing with the now dead by-catch. In addition, this present practice dictates that trawling ceases while the catch is handled.

It is an object of this invention to provide a skimming trawl net mounted on a trawling vessel with right and left retractable skimmer booms pivotally mounted at the stern of the trawling vessel, with a net arm mounted to each boom and a buoyantly adjustable roller mounted in a gimbal at the lower end of each net arm, and having a trawl net being pulled behind the trawling vessel so that the net cannot get into the vessel propeller, with a mouth having a top edge and a bottom edge with the ends of the top edge attached to the outboard ends of the skimmer booms and the ends of the bottom edge attached to the bottom of the net arms. It is further intended that the trawl net have a bag end, a bag loop for tying off the bag and a tag line for pulling the bag loop tight and also retrieving the catch in the bag by raising to the fantail of the vessel for dumping.

It is a further object of this invention that the inventive skimming trawl system be retractable for storage on the trawling vessel without disassembly and the stored system and vessel would not exceed highway height limits for transporting on a trailer on any truck route.

### BRIEF DESCRIPTION OF THE DRAWINGS

FIG. 1 is a rear perspective view of a trawling vessel equipped with the inventive skimming trawl system.

FIG. 2 is a perspective view of a buoyant watertight roller mounted on the bottom end of each net arm attached to a skimmer boom.

FIG. 3 is an overhead view of a trawling vessel equipped with the inventive skimming trawl system moving forward with a skimming trawl net deployed.

FIG. 4 shows the bag end of the skimming trawl net being tied off by a tag line to retain the catch before retrieval to the trawling vessel.

FIG. 5 shows the bag end of the skimming trawl net being retrieved by the tag line after being tied off.

FIG. 6 is a rear perspective view of a trawling vessel equipped with the inventive skimming trawl system showing the skimmer booms being raised for placement in a storage position for travel.

FIGS. 7 and 8 show the turning of the booms to set in place for travel.

FIG. 9A is a side view of a trawling vessel equipped with the inventive skimming trawl system on a trailer with skimmer booms in place for travel.

FIG. 9B is a side view of a trawling vessel equipped with the inventive skimming trawl system on a trailer with skimmer booms in place for travel showing the trawl net rolled and lashed to the skimmer booms.

FIG. 10 is an overhead view of a trawling vessel equipped with the inventive skimming trawl system with both skimmer booms stored for travel.

FIG. 11 is an overhead view of a trawling vessel equipped with the inventive skimming trawl system with one skimmer boom stored for travel.

FIG. 12 is a perspective view of a trawling vessel equipped with the inventive skimming trawl system with both skimmer booms stored for travel.

FIG. 13 is a rear perspective view of a trawling vessel showing details of the boom mast.

### DETAILED DESCRIPTION OF THE INVENTION

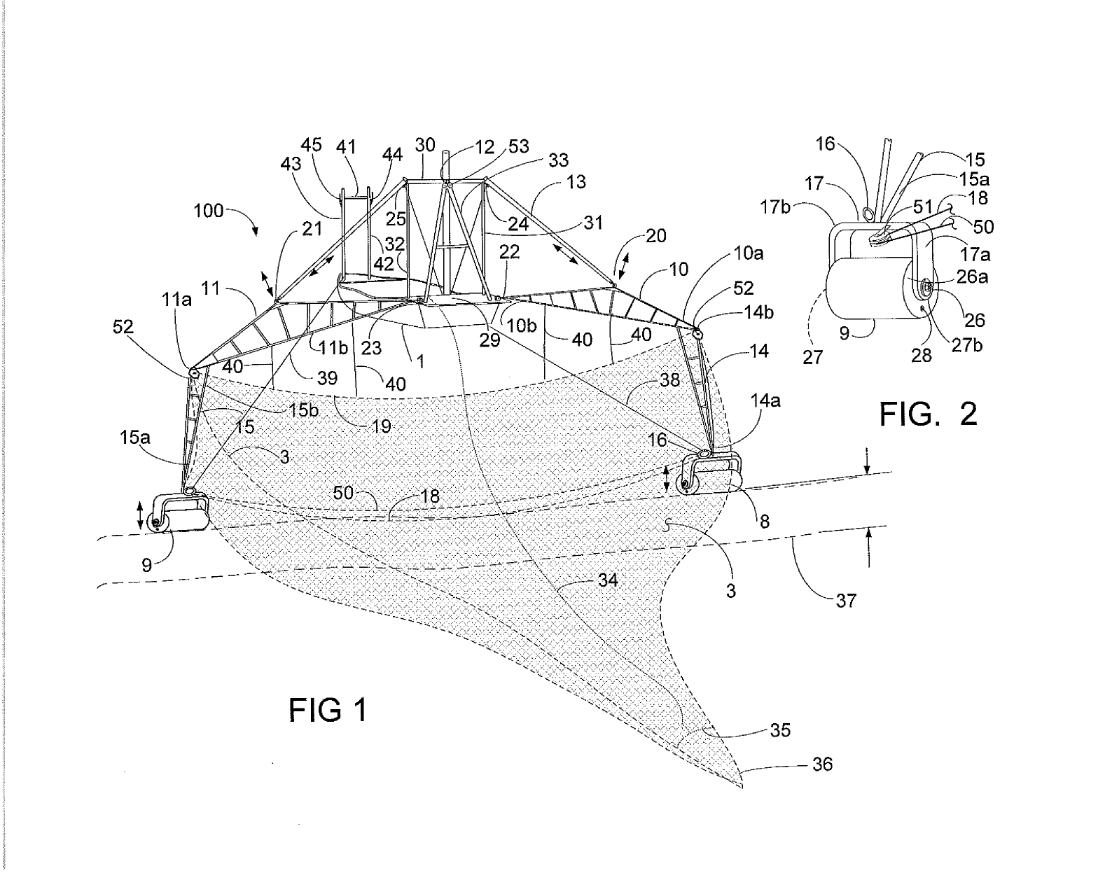

In FIG. 1, a trawling vessel 1 equipped with the inventive skimming trawl system 100 is shown from a rear view with a right skimmer boom 10 and a left skimmer boom 11 each having an inboard end and an outboard end and deployed and supported by boom cables 13 supported on a boom mast 12. Also shown is a boom support frame 30 with right and left support posts, 31 and 32 respectively along with a boom support frame brace 33. The boom cables 13 are drawn through right and left boom lifting pads 20 and 21 through right and left cable pulleys 24 and 25 respectively. There is a right and left skimmer boom pivot 22 and 23 respectively on the fantail 29 in proximity of the stern 49 of the trawling vessel 1 to receive the inboard ends of the right and left skimmer booms 10 and 11. Fixed to the outboard end 10a of the right skimmer boom 10 is the upper end 14b of a right net arm 14 and fixed to the outboard end 11a of the left skimmer boom 11 is the upper end 15b of a left net arm 15.

At the bottom end 14a of the right net arm 14 is a right roller gimbal 16 mounted with a right roller 8. At the bottom end 15a of the left net arm 15 is a left roller gimbal 17 mounted with a left roller 9.

As is apparent from FIG. 1, the right and left skimmer booms 10 and 11 respectively with their respective attached right and left net arms, 14 and 15, can be lowered or raised on their respective boom pivots 22 and 23 by boom cables 13 to accommodate different water depths so that the right roller 8 and the left roller 9 would roll on the sea bottom.

Also shown in FIG. 1 is the trawl net 3 with a forward net mouth held in a substantially rectangular shape with two upper corners and two lower corners by the right and left net arms. The two upper corners of the net mouth are attached at the upper ends 14b and 15b of the net anus 14 and 15. The two lower corners of the net mouth are attached at the lower ends 14a and 15a of the net arms 14 and 15. There is a net mouth upper edge 19 with a right and left end. The net mouth upper edge 19 is also commonly called a cork line in that it is fitted with corks or other buoyancy devices to keep the net mouth upper edge 19 at or near the surface of the water. At both the right and left ends of the net mouth upper edge 19 are lines fed through double pulleys 52, one mounted on the right to the upper end 14b of the right net arm 14 and one mounted on the left to the upper end 15b of the left net arm 15. Also shown on the forward net mouth is the net mouth lower edge 18 with a right and left end. The net mouth lower edge is also commonly called a lead line in that it is fitted with lead weights to keep the net mouth lower edge 18 at or near the sea bottom 37. At both the right and left ends of the net mouth lower edge 18 are lines fed through double pulleys 51, one mounted on the right to the right roller gimbal 16 and one mounted on the left to the left roller gimbal 17. These lines from the right and left ends of the net mouth lower edge 18 are then fed the double pulleys 52. The lines from both the right and left ends of the net mouth upper edge 19 and the right and left ends of the net mouth lower edge 18 are then led from the double pulleys to right and left cleats on the deck of the trawling vessel 1 for lashing of these lines. There will be at least one cleat on the right and left side of the trawling vessel 1 for the lines from the net mouth upper edge 19 and at least one cleat on the right and left side of the trawling vessel 1 for the lines from the net mouth lower edge 18. These lines from the ends of the net mouth upper edge 19 and the ends of the net mouth lower edge 18 allow the trawl net 3 to be disconnected from the trawling vessel 1 in the event that the trawl net 3 becomes snagged or entangled on an obstruction on the ocean bottom. Once disconnected, the net mouth upper edge 19 will float and the location of the trawl net 3 can be marked with a flotation device for retrieval.

It is understood that the actual length of the net mouth upper edge 19 is generally less than the distance between the upper double pulleys 52 and likewise the actual length of the net mouth lower edge 18 is generally less than the distance between the lower double pulleys 51. The actual distances will depend on the angle of deployment of the right and left skimmer booms 10 and 11 as required for the rollers 8 and 9 to roll on the sea bottom 37 at a particular water depth. The lines running from the corners of the net mouth upper edge 19 through the pulleys 52 and the lines running from the corners of the net mouth lower edge 18 through the pulleys 51 can be used to adjust the shape and tautness of the net mouth upper and lower edges 19 and 18 during the trawling operation.

Also shown in FIG. 1 is a tickler chain 50 with a right and left end in front of the net mouth lower edge 18. It is intended that the tickler chain 18 is pulled along the sea bottom ahead of the net mouth bottom edge 18 to cause shrimp to jump up and be swept into the moving trawl net 3. The right and left ends of the tickler chain 50 are fed through the lower double pulleys 51 mounted on the right and left roller gimbals 16 and 17 respectively. The right end of the tickler chain 50 is then led to a right lashing cleat on the deck of the trawling vessel 1 and the left end of the tickler chain 50 is then led to a left lashing cleat on the deck of the trawling vessel 1.

Also shown in FIG. 1 is a plurality of trawl net lashing lines 40 hanging from the bottom edge 10b of the right boom 10 and from the bottom edge 11b of the left boom 11. These lashing lines 40 are used to lash the trawl net 3 when the net 3 is retrieved and bundled for storage and transit. In addition, there are shown two boom restraining lines 38 and 39, each with a forward end attached to the bow of the trawling vessel 1 and an aft end attached to the bottom end 14a of the right net arm 14, and the bottom end 15a of the left net arm 15 respectively. These boom restraining lines 38 and 39 hold the right skimmer boom 10 and the left skimmer boom 11 in position while the trawling vessel 1 is moving forward in deployment of the inventive skimming trawl system 100.

At the forward end of the trawling vessel 1 is also shown a forward boom storage frame 41 with a right post 42 and a left post 43. On the right post 42 is a right boom support hook 44 for storage of the right boom 10 and the right net arm 14. Likewise, on the left post 43 is a left boom support hook 45 for storage of the left boom 11 and the left net arm 15.

As shown in the FIGS. 1, 3, 4 and 5, the trawl net 3 has an elongated tapering shape that ends in a bag 36 at the aft end of the net 3. For purposes of emptying the bag, the aft end of the net is cinched closed by suitable lashing that can be released to empty the bag on the fantail 29 of the trawling vessel 1. On a larger vessel, the bag 36 may be emptied on the vessel deck. In the inventive trawling system 100, as the trawling vessel moves forward with the net 3 deployed and configured as shown in FIG. 1, the desired catch and by-catch are trapped in the bag 36. At a distance forward of the aft end of the net 3, is a bag loop 35 configured to close the bag by use of a tag line 34 pulling from the support mast 12 through a tagline pulley 53. When the tag line 34 is pulled, the bag loop 35 tightens around the net 3 and secures the desired catch in the bag 36. Typically a series of rings may be sewn around the net 3 at the location of the bag loop 35 and the tag line 34 threaded through the rings. Once the bag loop 35 is tightened, the tag line 34 continues to be pulled and the bag 36 is drawn up and over the fantail 29 and the catch released or dumped on the fantail 29 by unlashing the aft end of the net 3. The aft end of the net 3 is then relashed and the tag line loosened to allow the bag 36 back into the water with the bag loop 35 untightened. It is intended that this retrieval and emptying of the catch in the bag 36 and return of the bag 36 to the water be done while the trawling vessel continues to move forward catching shrimp in the forward portion of the net 3. When the bag 36 is returned to the water any catch in the forward portion of the net 3 will be swept back into the bag for the next retrieval cycle.

FIG. 2 shows a perspective view of the left roller 9 mounted in the left roller gimbal 17 affixed to the bottom end 15a of the left net arm 15. As shown the roller 9 has a right end 26a with a right roller pin 26 inserted into the right arm 17a of the left gimbal 17, and a left end 27b with a left roller pin 27 inserted into the left arm 17b of the left gimbal 17. In one or both of the ends 26a or 27b is an access plug 28. It is understood that the right roller 8 is mounted in similar fashion in the right roller gimball 6 affixed to the bottom end 14a of the right net arm 14.

The access plug 28 allows the roller 9 or 8 to be filled fully or partially with water to adjust the buoyant properties of the rollers 9 and 8.

In practice the inventive system 100 has been implemented on a relatively small 26 foot trailered vessel with a 40 foot net without boards or bullets and can be designed to handle at least a 50 foot net. Using the trawl net as a skimmer is fast and efficient allowing for frequent pulling of the net bag.

On a 26′ by 8′ test vessel, when the outboard end of a skimmer boom 10 or 11 with attached net arm 14 or 15 and roller 8 or 9 respectively is placed on a scale, the weight is approximately 90 lbs. A roller 2′ long and 12″ diameter will float approximately 80 lbs of weight, so the net weight rolling on the sea bottom is only 10 lbs.

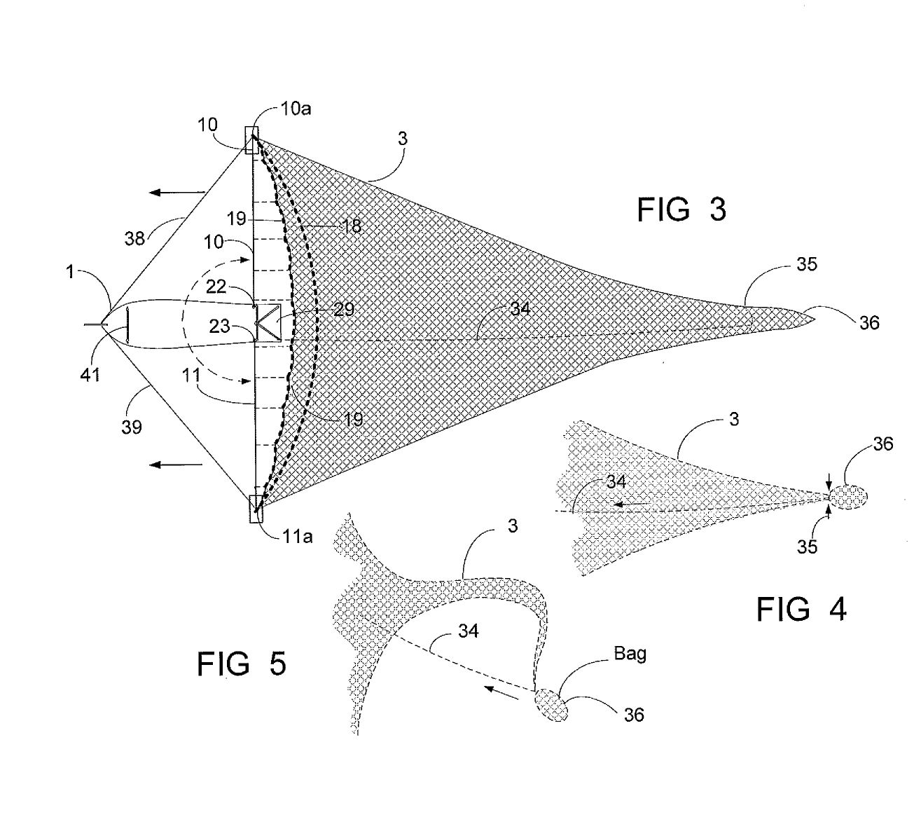

An overhead view of a trawling vessel 1 equipped with the inventive skimming trawl system 100 is depicted in FIG. 3 pulling the trawl net 3 as the vessel 1 moves forward from right to left. As shown the right skimmer boom 10 and the left skimmer boom 11 have been swung outboard on their respective pivots 22 and 23 to a position approximately transverse to the direction of motion of the vessel 1. The right and left skimmer booms 10 and 11 with their respective net arms 14 and 15 are restrained from swinging further aft by a right boom restraining line 38 and a left boom restraining line 39 respectively with the forward end of each restraining line 38 and 39 attached to the vessel 1 at the bow. The aft end of each restraining line 38 and 39 is attached to the bottom end 14a of the right net arm 14, and the bottom end 15a of the left net arm 15 respectively.

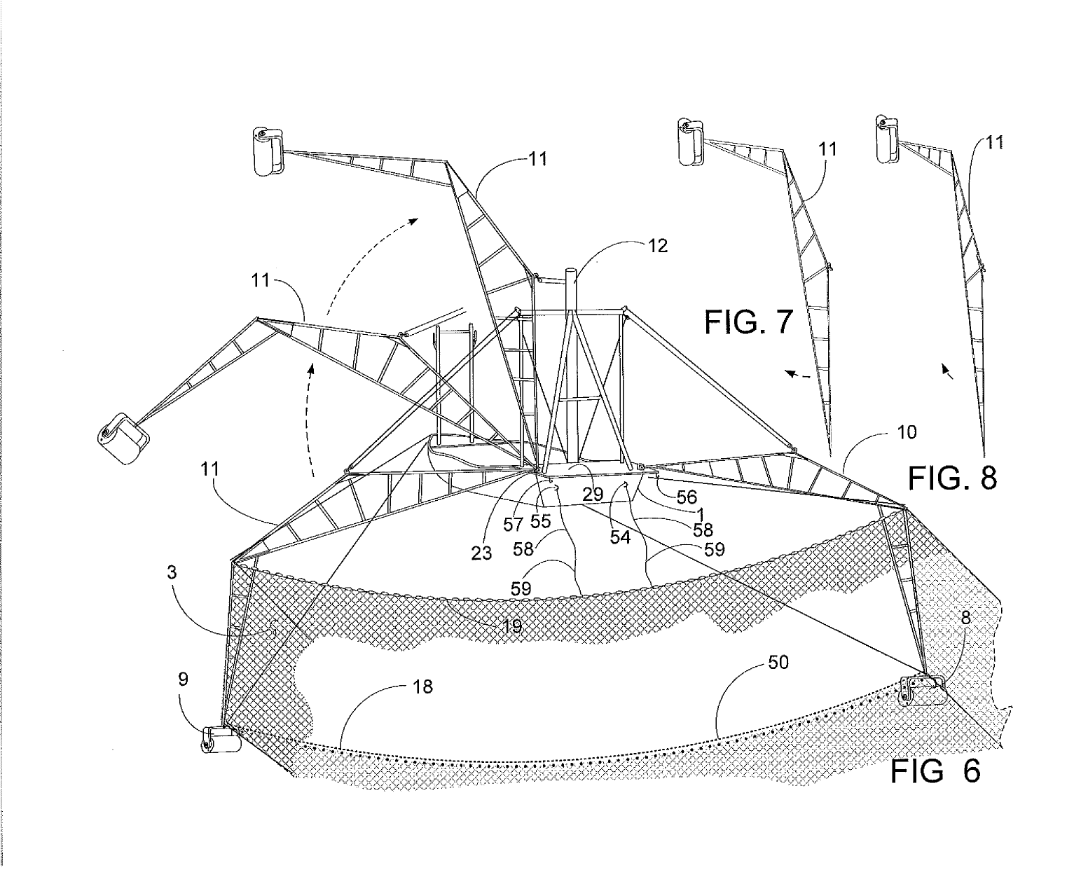

While not shown in FIG. 3, it is intended that the net mouth top edge 19 or cork line be above the water line at the trawler stern 49 below the fantail 29 when trawling. As shown in FIG. 6, there are two cork line lift lines 58 attached to the net mouth top edge 19 and fed through starboard and port transom loops 54 and 55. These lift lines 58 are used to lift the net mouth top edge 19 to the trawler stern 49 and the lift lines 58 are then secured to cleats on the deck of the trawling vessel 1.

Also depicted in FIG. 3 is the deployed trawl net 3 with the net mouth top edge 19, the net mouth bottom edge 18, the net bag 36 at the end of the net, the bag loop 35, and the tag line 34.

FIGS. 4 and 5 depict the steps involved in tying off the bag 36 at the bag loop 35 with the tag line 34 and then retrieving the bag 36 loaded with catch by continuous pulling of the tag line 34 from the tagline pulley 53.

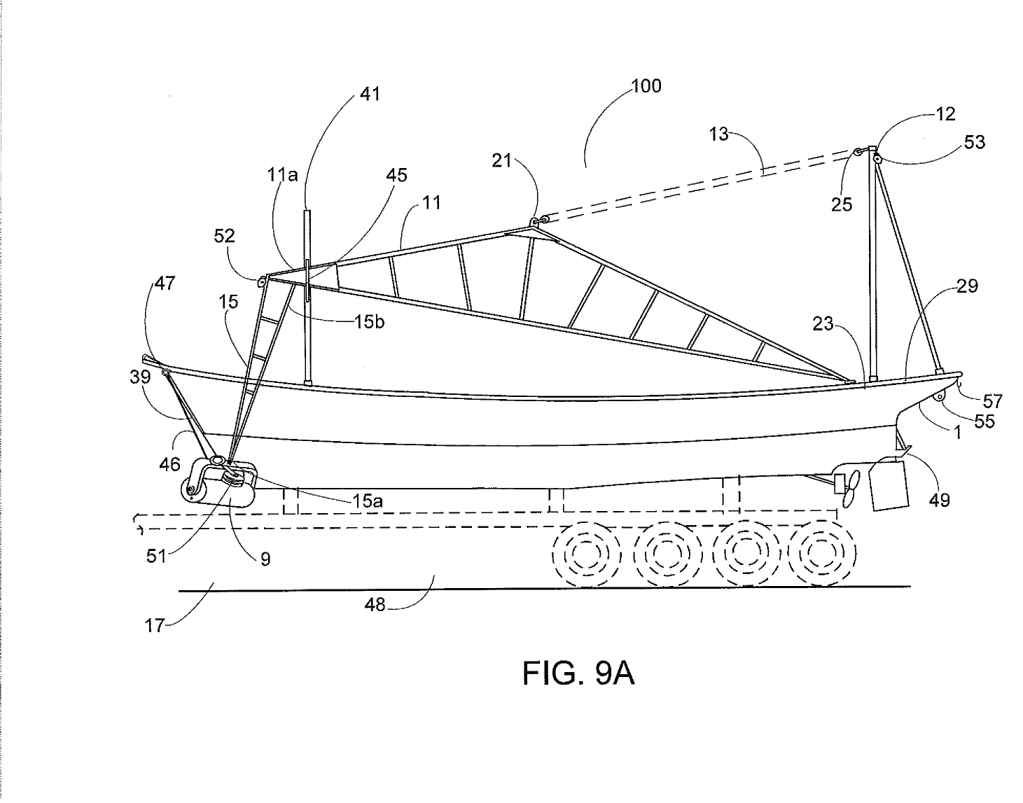

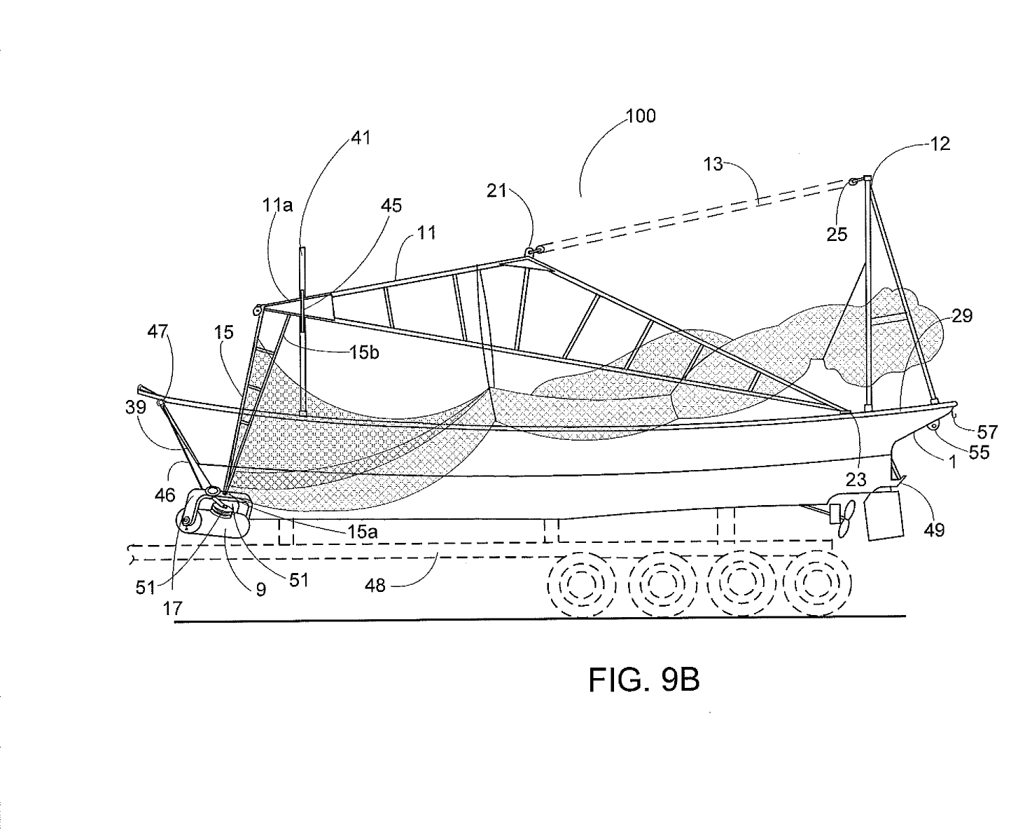

FIG. 6 depicts the raising of the skimmer booms 10 and 11 for placement on a forward boom support frame 41 for storage and travel. FIGS. 7 and 8 show the inward turning of the left skimmer boom 11 before storage on the boom support frame 41, in order to have the left net arm 15 as close to the port side of the trawling vessel 1 to minimize width for purposes of transporting the vessel 1 complete with skimmer booms 10 and 11, net arms 14 and 15, rollers 8 and 9, and furled and lashed net 3, all on a trailer 48 for highway travel as shown in the side view of FIG. 9B. It is specifically intended that the net 3 be stored with the skimmer booms 10 and 11. As shown in FIG. 9A, the left skimmer boom 11 is cradled in a left boom support hook 45 mounted on the left post 43 of the forward boom storage frame 41 at the forward end of the trawling vessel 1 near the bow 46. Also shown on the bow is a padeye 47 for the boom restraining lines 38 and 39. The boom support cable 13 is also shown connected to the left boom lifting pad 21 and the left boom cable pulley mounted on the boom mast 12.

As shown in FIG. 6 there is a starboard fantail hook 56 on the starboard aft outboard corner of the fantail 29 and a port fantail hook 57 on the port aft outboard corner of the fantail 29, along with the two cork line lift lines 58 attached to the net mouth top edge 19 and two lead line lifting lines 59 attached to the net mouth bottom edge 18. While not shown, similar lift lines would be provided for the tickler chain 50.

Upon completion of trawling with the inventive trawl system and method, the tag line 34 would be used to retrieve the bag 36 at the aft end of the net 3 and hoist the bag 36 up the support mast 12 on the tagline pulley 53. In addition the tapered portion of the net 3 forward of the bag 36 would be bundled, lashed and also lifted up the support mast 12 and draped above the fantail 29. At this point, the cork line lift lines 58 would be loosened from the transom loops 54 and 55 and the net mouth upper edge 19 hooked in the fantail hooks 56 and 57. The lead line lift lines 59 would be used to lift the net mouth lower edge 18 and hook it in the fantail hooks 56 and 57. Similarly the tickler chain 50 would be lifted and hooked in the fantail hooks 56 and 57. With the net mouth upper edge 19, the net mouth lower edge 18, and the tickler chain 50 all hooked in the fantail hooks 56 and 57, and the aft end of the net 3 and the bag 36 draped from the support mast 12, the remainder of the net 3 will now float on the surface of the water behind the trawling vessel 1. The right and left skimmer booms 10 and 11 can then be lifted by the boom cables 13 allowing the net 3 to be gathered and bundled for lashing to the booms with lashing lines 40. Once lifted the skimmers booms 10 and 11 can then be swung forward with the lashed net 3 and placed in the respective support hooks 44 and 45. Once the booms 10 and 11 are placed in the respective support hooks 44 and 45, any net 3 still hanging can be lashed to the booms 10 and 11.

When the trawl net 3 has been stowed the right skimmer boom 10 with the attached right net arm 14 and the left skimmer boom 11 with the attached left net arm 15 can be swung forward on their respective boom pivots 22 and 23 and stored on the right and left sides of the trawler 1 and inboard of the trawler sides. This allows the trawler to maintain allowable heights for trailering on the highway.

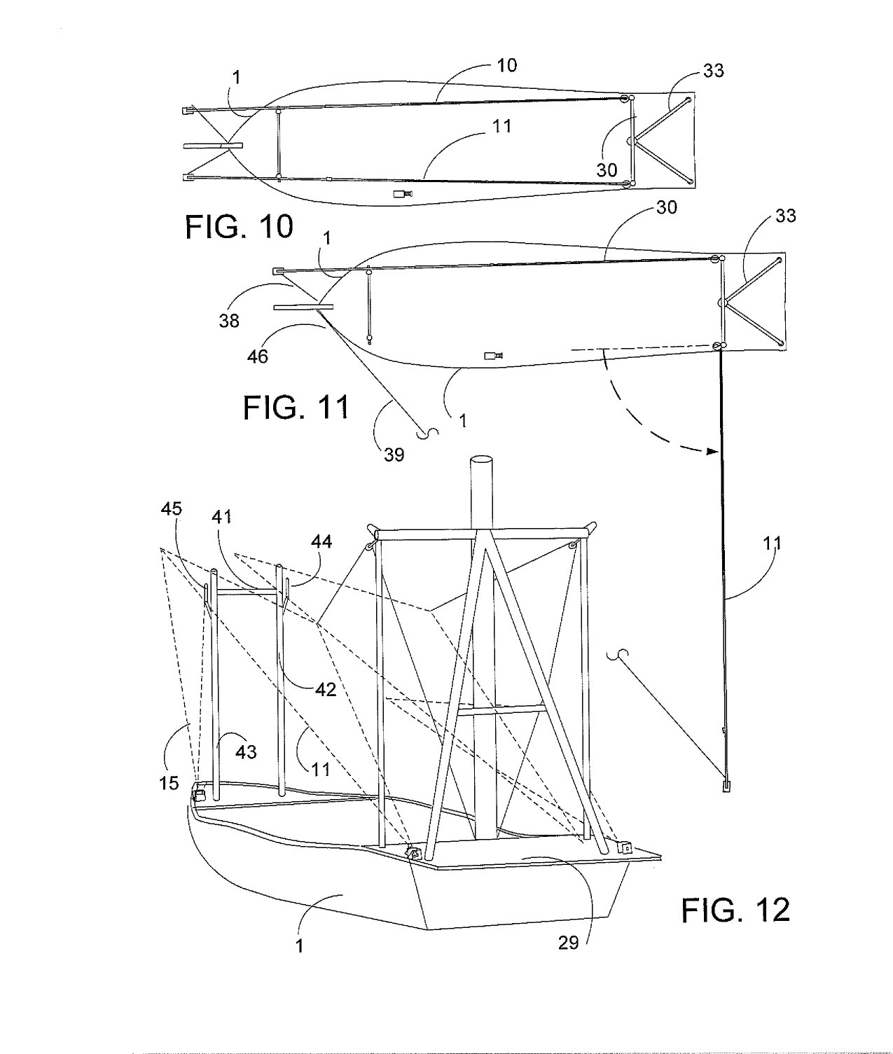

FIG. 10 shows an overhead view of the trawling vessel 1 with both skimmer booms 10 and 11 in the stored position and cradled on the forward boom storage frame 41. FIG. 11 shows an overhead view of the trawling vessel 1 with only one skimmer boom 10 in the stored position and cradled on the forward boom storage frame 41, while the other boom 11 is being pulled into storage position with the use of the left boom restraining line 39.

In FIG. 12, a schematic perspective view shows both skimmer booms 10 and 11 cradled in their respective support hooks 44 and 45. As shown in FIG. 9B, it is understood that the trawl net 3 would be rolled up and lashed with the lashing lines 40 and remain attached to the booms 10 and 11 and net arms 14 and 15 for storage and travel.

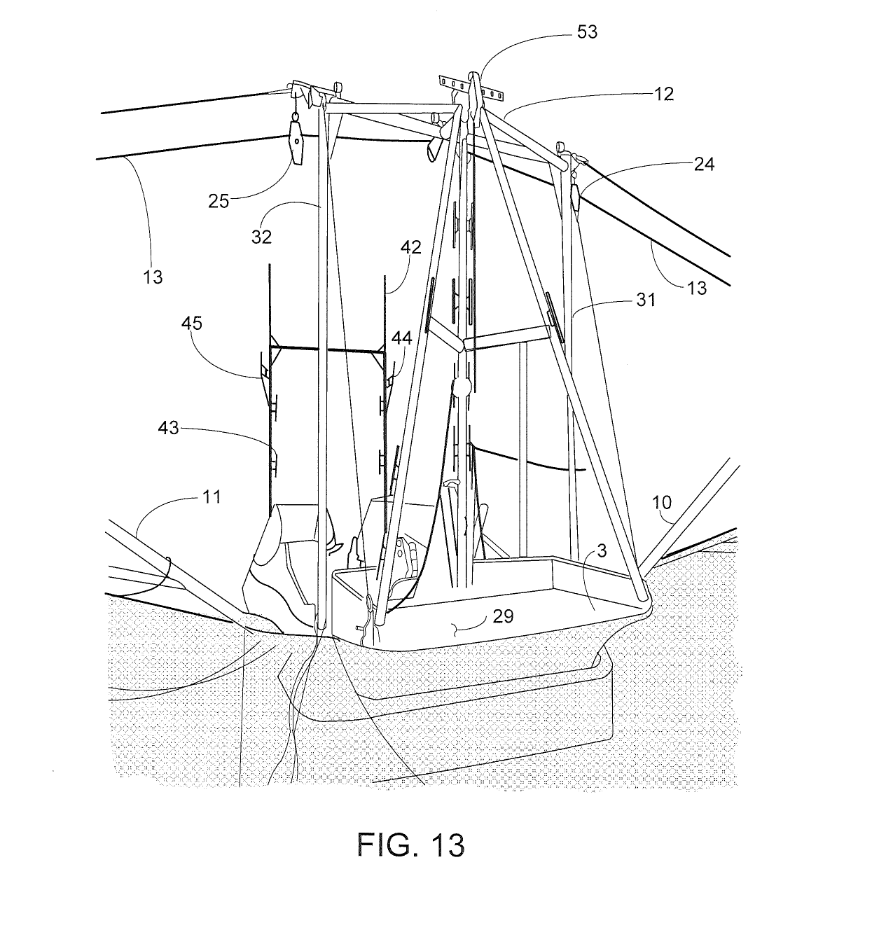

FIG. 13 shows a rear perspective view of a trawling vessel 1 showing details of the boom mast 12 with a top mounted tagline pulley 53.

1. An environmentally friendly and fully assembled skimming trawl system to minimize the destructive effects of bottom trawling for use in a body of water having a surface and a bottom, where the system comprises:
a) a trawling vessel with a bow and a stern, a right side and a left side, a deck, and a fantail at the stern:
b) a net having a forward end and an aft end with a net mouth on the forward end, a bag at the aft end, a bag loop forward of the bag, and a tagline for closing the bag and lifting the bag;
c) right and left skimmer booms with inboard and outboard ends, with the inboard ends pivoting on the fantail at the stern of the trawling vessel;
d) right and left net arms holding the net mouth in a substantially rectangular opening, each net arm having a bottom end and an upper end, each upper end fixed to the outboard end of the respective right and left skimmer booms;
e) right and left rollers each having a right and left end with an access plug in one or both of the ends of each roller to allow filling the rollers fully or partially with water to adjust the buoyancy of each roller, each roller mounted in a gimbal for rolling on the bottom of the body of water, each gimbal mounted respectively at the bottom end of the respective right and left net arms;
f) a boom mast with right and left cable pulleys for raising and lowering the skimmer booms and a pulley for operating the tagline, and;
g) a forward boom storage frame mounted on the trawling vessel deck in proximity of the bow with right and left support hooks for storing without disassembly the right and left skimmer booms with attached net arms, rollers and net for transit on water or on a trailer.

2. (canceled)

3. The skimming trawl system of claim 1, where the net mouth further comprises a net mouth upper edge cork line with right and left ends each connected to lines carried through pulleys on the upper ends of the net arms for lashing of those lines connected to the right and left ends of the net mouth upper edge cork line on the deck of the trawling vessel, further comprising a net mouth lower edge lead line with right and left ends each connected to lines carried through pulleys on the respective lower ends of the net arms and through pulleys on the respective upper ends of the net arms for lashing of those lines connected to the right and left ends of the net mouth lower edge lead line on the deck of the trawling vessel.

4. The skimming trawl system of claim 3, further comprising a tickler chain deployed on the bottom of the body of water in front of the net mouth lower edge lead line and having a right and left end with each end fed through a pulley on the lower ends of the respective net arms for lashing of each end of the tickler chain on the deck of the trawling vessel.

5. The skimming trawl system of claim 4, where the stored skimmer booms, net arms, rollers and net would not exceed the allowable height limit for trailer transit on highways and roads.

6. The skimming trawl system of claim 5, where the net mouth upper edge is pulled to the stern of the trawling vessel below the fantail and above the surface of the body of water.

7. An environmentally friendly method of skimming for shrimp to minimize the destructive effects of bottom trawling, comprising the following steps:
a) providing a trawling vessel on the ocean surface above the ocean bottom, said vessel having a bow and a stern, a right side and a left side, a deck, and a fantail at the stern, said trawling vessel equipped and assembled with a net having a forward end and an aft end with a net mouth on the forward end with a net mouth upper edge and a net mouth lower edge, a bag at the aft end, a bag loop forward of the bag, and a tagline for closing the bag and lifting the bag, right and left skimmer booms with inboard and outboard ends, with the inboard ends pivoting on the fantail at the stern of the trawling vessel, right and left net arms holding the net mouth in a substantially rectangular opening, each with a bottom end and an upper end, and each upper end fixed to the outboard end of the respective right and left skimmer booms, right and left rollers each having a right and left end with an access plug in one or both of the ends of each roller to allow filling the rollers fully or partially with water to adjust the buoyancy of each roller, each roller mounted in a gimbal, each gimbal mounted respectively at the bottom end of the respective right and left net arms, and a boom mast with right and left cable pulleys for raising and lowering the skimmer booms and a pulley for operating the tagline;
b) move the trawling vessel in a forward direction and deploy the right and left skimmer booms with attached net arms and net and gimbal mounted rollers in a direction transverse to the direction of the vessel with the net mouth attached to the net arms;
c) lower the right and left skimmer booms with their respectively affixed net arms and gimbal mounted rollers so that the rollers make rolling contact with the ocean bottom;
d) continue moving the trawling vessel in a forward direction to catch shrimp and, in periodic intervals while still moving forward, close the bag loop with the tagline and lift the bag on the boom mast, untie the aft end and dump the contents of the bag on the fantail for sorting of catch;
e) retie the aft end, open the bag loop and allow the bag back into the water to follow the moving trawling vessel and net.

8. The method of claim 7, where the deployment of the nets further comprises the step of pulling the net mouth upper edge to the stern of the vessel below the fantail above the ocean surface while moving the trawling vessel in a forward direction.

9. The method of claim 7, where the provided trawling vessel is capable of trailer transit without disassembly.

10. The skimming trawl system of claim 1 further comprises a trailer for transit without disassembly of the skimming trawl system.
